(19) United States
(12) Patent Application Publication
(10) Pub. No.: US 2016/0202579 A1
(43) Pub. Date: Jul. 14, 2016

(54) CURVED DISPLAY DEVICE

(71) Applicant: Samsung Display Co., Ltd., Yongin-Si (KR)

(72) Inventors: Jong-Keun KIM, Seoul (KR); Jeong Man SON, Suwon-si (KR); Jin Young LEE, Cheonan-si (KR); Dong Hee Ye, Buk-gu (KR)

(21) Appl. No.: 14/982,766

(22) Filed: Dec. 29, 2015

(30) Foreign Application Priority Data
Jan. 8, 2015 (KR) 10-2015-0002963

(51) Int. Cl. G02F 1/1362; G02F 1/1343; G02F 1/1368

(52) U.S. Cl. CPC G02F 1/136209; G02F 1/1368; G02F 1/13624; G02F 1/134309; G02F 2001/134345

(57) ABSTRACT

A curved display device may include a pixel electrode, a transistor, a curved light blocking member, and a light blocking portion. The transistor may be electrically connected to the pixel electrode. The curved light blocking member may overlap the transistor. The light blocking portion may be directly connected to the curved light blocking member and may be perpendicular to a geometric radius of curvature associated with the curved light blocking member.

### CROSS-REFERENCE TO RELATED APPLICATION

This application claims priority to and the benefit of Korean Patent Application No. 10-2015-0002963 filed in the Korean Intellectual Property Office on Jan. 8, 2015; the entire contents of the Korean Patent Application are incorporated herein by reference.

### BACKGROUND

(a) Technical Field

The present invention is related to a curved display device. For example, the curved display device may be a curved liquid crystal display device.

(b) Description of the Related Art

A display device (such as a liquid crystal display device) may include two panels with electric field generating electrodes, such as a pixel electrode and a common electrode, and may include a liquid crystal layer positioned between the two panels. The display device may generate an electric field in the liquid crystal layer by applying a voltage to the electric field generating electrodes to control orientations of liquid crystal molecules of the liquid crystal layer for controlling transmission of light through the liquid crystal layer, such that images may be displayed.

A curved display device (such as a curved liquid crystal display device) may provide enhanced viewer experience. Nevertheless, misalignment between curved panels of a curved display device may cause undesirable light leakage and/or decrease of light transmittance.

The above information disclosed in this Background section is for enhancement of understanding of the background of the invention. The Background section may contain information that does not form the prior art that is already known in this country to a person of ordinary skill in the art.

### SUMMARY

Embodiments of the present invention may be related to a curved display device, such as a curved liquid crystal display device. Sufficient light transmission of the display device may be provided, and/or light leakage in the display device may be minimized or substantially prevented, such that the curved display device may display images with satisfactory quality.

An embodiment of the present invention may be related to a curved display device. The curved display device may include a pixel electrode, a first thin film transistor, a first curved light blocking member, and a light blocking portion. The first thin film transistor may be electrically connected to the pixel electrode. The first curved light blocking member may overlap the first thin film transistor. The light blocking portion may be directly connected to the first curved light blocking member and may be perpendicular to a first geometric radius of curvature associated with the first curved light blocking member.

The light blocking portion may extend perpendicular to the first curved light blocking member in a plan view of the curved display device.

The curved display device may include a second pixel electrode and a second thin film transistor, which may be electrically connected to the second pixel electrode. The first thin film transistor may be oriented according to a first geometric plane. The second thin film transistor may be oriented according to a second geometric plane. The second geometric plane may be different from the first geometric plane and may not be parallel to the first geometric plane. The first curved light blocking member may overlap (and cover) both the first thin film transistor and the second thin film transistor.

The curved display device of claim 1, further comprising a second thin film transistor,

The pixel electrode may include a first subpixel electrode and a second subpixel electrode. The first thin film transistor may be electrically connected to the first subpixel electrode. The second thin film transistor may be electrically connected to the second subpixel electrode. The first curved light blocking member may cover both the first thin film transistor and the second thin film transistor.

The first subpixel electrode may be aligned with the second subpixel electrode in a direction perpendicular to a second geometric radius of curvature associated with the first curved light blocking member.

The first thin film transistor may overlap the first curved light blocking member in an extending direction of the second geometric radius of curvature or a third geometric radius of curvature associated with the first curved light blocking member.

The first subpixel electrode may receive a first voltage. The second subpixel may receive a second voltage. A value of the second voltage may be unequal to a value of the first voltage.

The curved display device may include a curved gate line, which may be electrically connected to a gate electrode of the first thin film transistor and may overlap the first curved light blocking member.

The curved display device may include a second thin film transistor and a second curved light blocking member, which may overlap the second thin film transistor. The pixel electrode may include a first subpixel electrode and a second subpixel electrode. The first thin film transistor may be electrically connected to the first subpixel electrode. The second thin film transistor may be electrically connected to the second subpixel electrode.

At least one of the first subpixel electrode and the second subpixel electrode may be positioned between the first thin film transistor and the second thin film transistor in a plan view of the curved display device.

The second curved light blocking member may be parallel to the first curved light blocking member.

A first side of the first subpixel electrode may be parallel to the first curved light blocking member in a plan view of the curved display device. A second side of the first subpixel electrode may be parallel to the light blocking portion in the plan view of the curved display device. The first side of the first subpixel electrode may be longer than the second side of the first subpixel electrode.

The curved display device may include a first curve data line and a second curved data line. The first curved data line may be electrically connected to a source electrode of the first thin film transistor and may overlap the first curved light blocking member. The second curved data line may be electrically connected to a source electrode of the second thin film transistor and may overlap the second curved light blocking member.

The curved display device may include a gate line, which may be electrically connected to a gate electrode of the first thin film transistor and may overlap the light blocking portion.

The light blocking portion may be positioned between the first thin film transistor and the second thin film transistor in a plan view of the curved display device.

The curved display device may include a first driver and a second driver. The first driver may generate a first set of signals for a first portion of the curved display device. The second driver may generate a second set of signals for a second portion of the curved display device. The first curved light blocking member may be positioned between the first driver and the second driver in a plan view of the curved display device.

The curved display device may include a first driver and a second driver. The first driver may generate a first set of signals for a first portion of the curved display device. The second driver may generate a second set of signals for a second portion of the curved display device. The first curved light blocking member may be aligned with the first driver in a direction in a plan view of the curved display device and may not be aligned with the second driver in the direction in the plan view of the curved display device.

An embodiment of the present invention may be related to a curved display device, which may include the following elements: a substrate, which may be bent with respect to a first direction; a first thin film transistor; a pixel electrode electrically connected to the first thin film transistor; and a light blocking member disposed on the substrate and comprising a first light blocking portion, wherein the first light blocking portion may extend in the first direction in a plan view of the curved display device and may overlap the first thin film transistor.

The curved display device may include the following elements: a gate line electrically connected to a gate electrode of the thin film transistor; and a data line electrically connected to a source electrode of the thin film transistor. The first light blocking portion may overlap at least one of the gate line and the data line.

The curved display device may include a second thin film transistor. The first thin film transistor may be electrically connected to a first subpixel electrode of the pixel electrode. The second thin film transistor may be electrically connected to a second subpixel electrode of the pixel electrode. The light blocking member may further include a second light blocking portion. The second light blocking may extend perpendicular to the first light blocking portion in the plan view of the curved display device and may be positioned between the first thin film transistor and the second thin film transistor in the plan view of the curved display device.

An embodiment of the present invention may be related to a curved display device, which may be bent with respect to a first direction. The curved display device may include the following elements: a first substrate and a second substrate facing each other; a thin film transistor disposed on the first substrate; a pixel electrode connected to the thin film transistor; and a light blocking member disposed on the second substrate and including a first light blocking member and a second light blocking member. The first light blocking member may extend in the first direction in a plan view of the display device and may overlap the first thin film transistor. The second light blocking member may extend in a second direction. The curved display device may further include a liquid crystal layer interposed between the first substrate and the second substrate.

The curved display device may further include a plurality of pixel areas, wherein the pixel electrode may be disposed within the pixel areas.

Each pixel area may be shaped like a quadrangle including two long sides and two short sides, and the short sides may be parallel to the first direction.

The long sides may be parallel to the second direction.

The second direction may be perpendicular to the first direction.

The pixel electrode may include a first subpixel electrode and a second subpixel electrode to which different voltages are applied.

The thin film transistor may be disposed between the first subpixel electrode and the second subpixel electrode.

The curved display device may further include a gate line and a data line that are disposed on the first substrate and connected to the thin film transistor, wherein the gate line may extend in the first direction and the data line may extend in the second direction.

The gate line may overlap the first light blocking member, and the data line may overlap the second light blocking member.

The curved display device may further include a driving part that supplies signals to the gate line and the data line, wherein the driving part may be disposed on one edge of the first substrate.

The curved display device may further include a driving part that supplies signals to the gate line and the data line, wherein the driving part may be disposed on opposite edges of the first substrate.

Each pixel area may be shaped like a quadrangle including two long sides and two short sides, and the long sides may be parallel to the first direction.

The short sides may be parallel to the second direction.

The second direction may be perpendicular to the first direction.

The thin film transistor may be disposed between the pixel areas adjacent in the second direction.

The curved display device may further include a gate line and a data line that are disposed on the first substrate and connected to the thin film transistor, wherein the gate line may extend in the second direction, and the data line may extend in the first direction.

The gate line may overlap the second light blocking member, and the data line may overlap the first light blocking member.

The curved display device may further include a driving part that supplies signals to the gate line and the data line, wherein the driving part may be disposed on one edge of the first substrate.

The curved display device may further include a driving part that supplies signals to the gate line and the data line, wherein the driving part may be disposed on opposite edges of the first substrate.

According to embodiments of the present invention, in a curved display device, e.g., a curved display device, even if there is misalignment between substrates (or panels) of the curved display device, pixel electrodes may not be significantly blocked by a light blocking member, and/or transistors may be substantially completed covered by a light blocking member. Therefore, sufficient light transmittance may be provided, and/or light leakage may be minimized or substantially prevented. Advantageously, the curved display device may display images with satisfactory quality.

### BRIEF DESCRIPTION OF THE DRAWINGS

FIG. 1 is a schematic perspective view illustrating a curved display device (e.g., a curved liquid crystal display device) according to an embodiment of the present invention.

FIG. 2 is a schematic plan view illustrating elements and/or structures in a curved display device according to an embodiment of the present invention.

FIG. 3 is an equivalent circuit diagram of a pixel of a curved display device according to an embodiment of the present invention.

FIG. 4 is a schematic plan view illustrating elements and/or structures in a pixel of a curved display device according to an embodiment of the present invention.

FIG. 5 is a schematic cross-sectional view taken along line V-V indicated FIG. 4 and illustrating elements and/or structures in a curved display device according to an embodiment of the present invention.

FIG. 6 is a schematic plan view illustrating elements and/or structures in a curved display device according to an embodiment of the present invention.

FIG. 7 is a schematic plan view illustrating elements and/or structures in a curved display device according to an embodiment of the present invention.

FIG. 8 is a schematic plan view illustrating elements and/or structures in a pixel of a curved display device according to an embodiment of the present invention.

FIG. 9 is a schematic plan view illustrating elements and/or structures in a curved display device according to an embodiment of the present invention.

### DETAILED DESCRIPTION OF THE EMBODIMENTS

Embodiments of the present invention are described with reference to the accompanying drawings. As those skilled in the art would realize, the described embodiments may be modified in various different ways, all without departing from the spirit or scope of the present invention.

Although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

In the drawings, thicknesses of layers, films, panels, regions, etc., may be exaggerated for clarity. Like reference numerals may designate like elements in the specification. When a first element (such as a layer, film, region, or substrate) is referred to as being “on” a second element, the first element can be directly on the second element, or one or more intervening elements may also be present. In contrast, when a first element is referred to as being “directly on” a second element, there are no intended intervening elements between the first element and the second element.

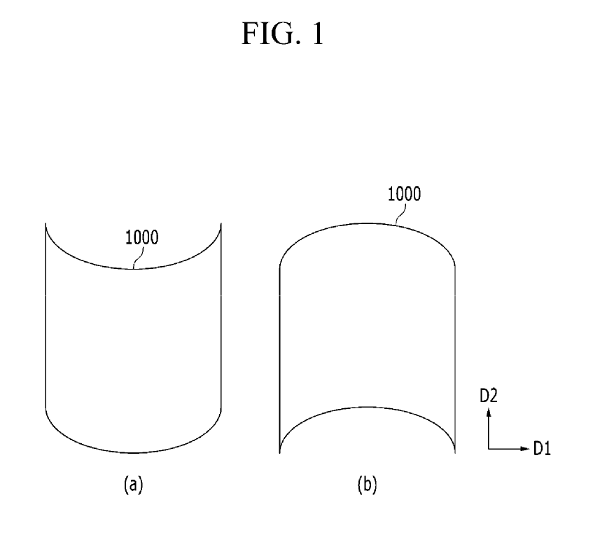

FIG. 1 is a schematic perspective view illustrating a curved display device 1000, e.g., a curved liquid crystal display device, according to an embodiment of the present invention.

As shown in FIG. 1, the curved display device 1000 may be bent with respect to a first direction D1. An image displaying side of the curved display device 1000 may be concave or convex with respect to a view of the curved display device 1000. The curved display device 1000 may include a light blocking member 220 for minimizing or preventing light leakage in the display device 1000. The light blocking member 220 may include a first-type light blocking member 220a (or first light blocking member 220a, for conciseness) and a second-type light blocking member 220b (or light blocking portion 220b or second light blocking member 220b, for conciseness). The first light blocking member 220a may be curved and may be bent with respect to the first direction D1. The second light blocking member may extend perpendicular to a first geometric radius R1 of curvature associated with the first light blocking member 220a and/or may extend in (or parallel to) a second direction D2, the second direction D2 being perpendicular to the first direction D1.

The curved display device 1000 may include subpixel electrodes 191h and 191l. The subpixel electrodes 191h and 191l may be aligned with each other in a direction perpendicular to a second geometric radius R2 of curvature associated with the first light blocking member 220a.

The curved display device 1000 may include a transistor Qh, with may be electrically to the subpixel electrode 191h. The transistor Qh may overlap the first light blocking member 220a in an extending direction of the second geometric radius R2 of curvature or a third geometric radius of curvature associated with the first light blocking member 220a.

The curved display device 1000 may include a transistor Qh2, which may be analogous to the transistor Qh and may be electrically to a subpixel electrode that is analogous to the subpixel 191h. The transistor Qh may be positioned on and/or oriented according to a first geometric plane. The transistor Qh2 may be positioned on and/or oriented according to a second geometric plane. The second geometric plane is different from the first geometric plane and is not parallel to the first geometric plane. The first light blocking member 220a may overlap the transistor Qh in a direction perpendicular to the first geometric plane and may overlap the transistor Qh2 in a direction perpendicular to the second geometric plane.

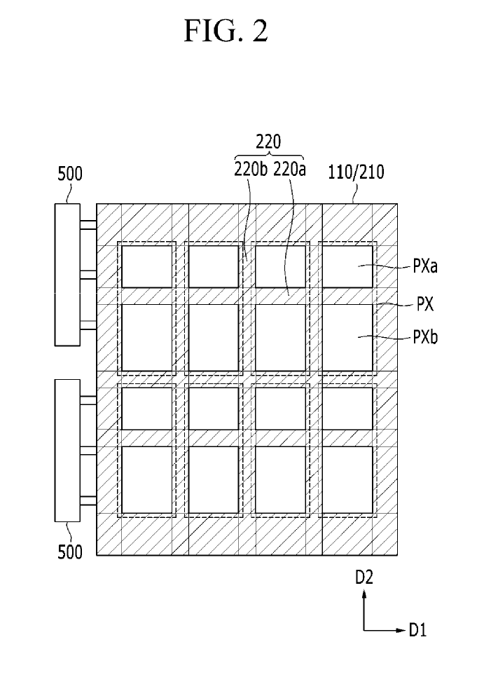

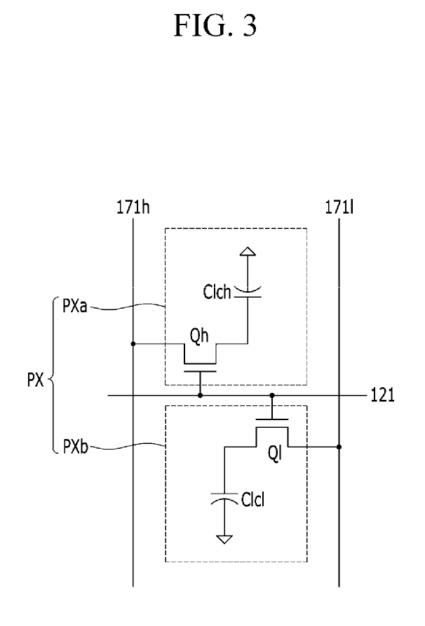

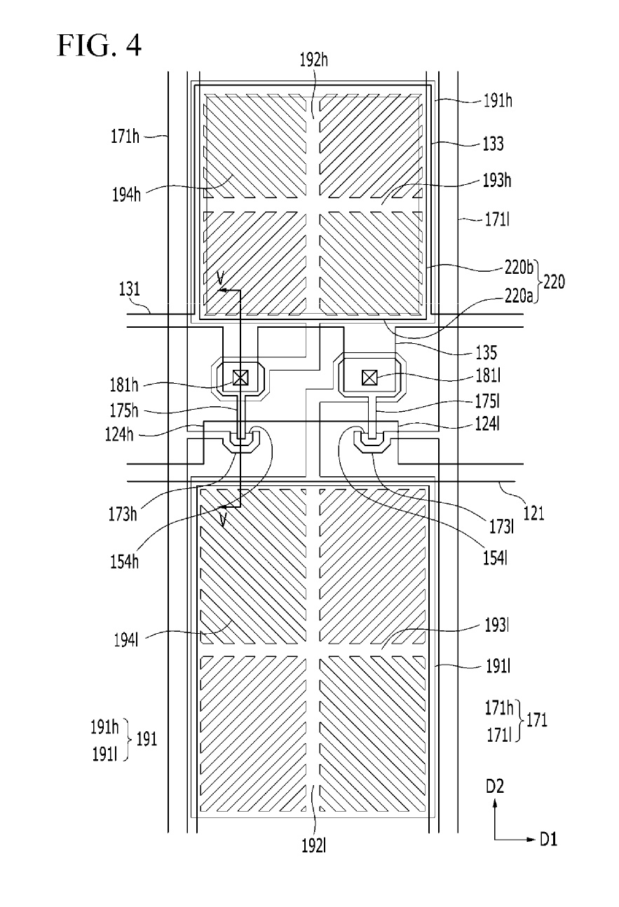

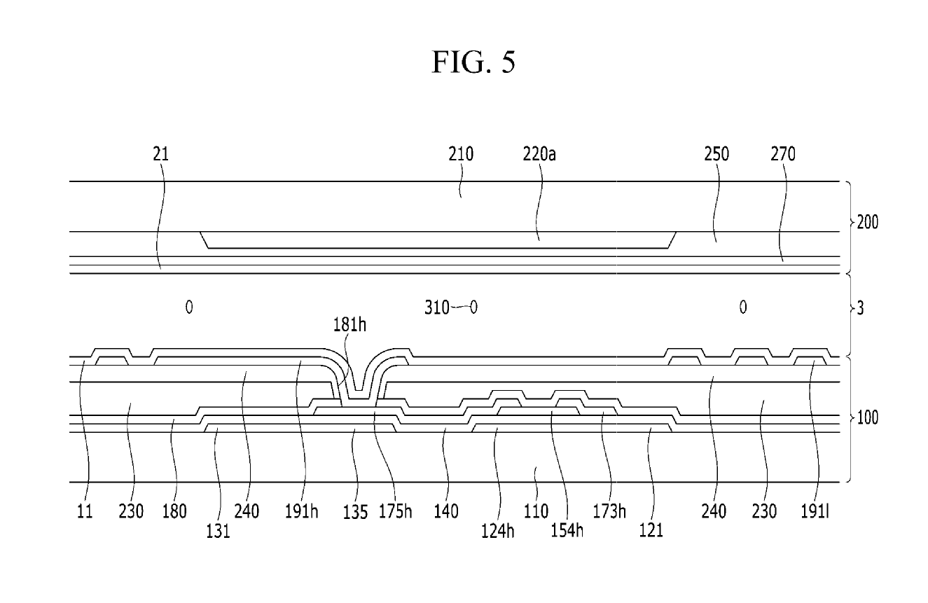

FIG. 2 is a schematic plan view (e.g., viewed from a direction perpendicular to both the first direction D1 and the second direction D2) illustrating the curved display device 1000 according to an embodiment of the present invention. FIG. 3 is an equivalent circuit diagram of a pixel of the curved display device 1000 according to an embodiment of the present invention. FIG. 4 is a schematic plan view illustrating elements and/or structures in the pixel of the curved display device 1000 according to an embodiment of the present invention. FIG. 5 is a schematic cross-sectional view taken along line V-V indicated in FIG. 4 according to an embodiment of the present invention.

Referring to FIG. 2, the curved display device 1000 (or display device 1000) includes a plurality of pixel areas PX. Each pixel area PX may have a substantially quadrangle shape including two substantially parallel long sides and two substantially parallel short sides. The short sides are parallel to the first direction D1 in the plan view of the display device 1000. The short sides may be straight or bent with respect to the first direction D1. The long sides are parallel to the second direction D2, which is perpendicular to the first direction D1.

Each of the pixel areas PX may include a first-type subpixel area PXa (or first subpixel area PXa) and a second-type subpixel area PXb (or second subpixel area PXb). The first subpixel area PXa and the second subpixel area PXb may be aligned with each other on in the second direction D2.

In an embodiment, each pixel area PX may include three or more subpixel areas. In an embodiment, each pixel area PX may not be split into a plurality of subpixel areas.

The curved display device 1000 includes a first substrate 110 and a second substrate 210 that are connected to each other. The light blocking member 220 may be formed on the first substrate 110 and/or the second substrate 210.

Portions of the light blocking member 220 may be disposed between the pixel areas PX. Portions of the light blocking member 220 may be disposed between first subpixel areas PXa and second subpixel areas PXb. In the plan view of the display device 1000, the first light blocking member 220a may extend in the first direction D1, and the second light blocking member 220b may extend in the second direction D2.

One or more driving parts 500 may be positioned at an edge of the first substrate 110 and/or at an edge of the second substrate 210. A driving part 500 may generate signals for driving the curved display device 1000.

Referring to FIG. 3, the curved display device 1000 includes a plurality of signal lines, which may include gate lines 121, first-type data lines 171h (or first data lines 171h ), and second-type data lines 171l (or second data lines 171l ). Pixel areas PX may border these signal lines 121, 171h, and 171l.

The gate lines 121 may be configured for transmitting gate signals. The first data lines 171h and the second data lines 171l may be configured for transmitting data voltages.

A first-type thin film transistor Qh (or first thin film transistor Qh) may be connected to a gate line 121 and a first data line 171h. A second-type thin film transistor Ql (or second thin film transistor Ql) may be connected to the gate line 121 and a second data line 171l.

A first-type capacitor Clch (or first capacitor Clch) connected to a first thin film transistor Qh may be formed in each first subpixel area PXa. A second-type thin film transistor Clcl (or second thin film transistor Clcl) connected to a second thin film transistor Ql may be formed in each second subpixel area PXb.

A first terminal of the first thin film transistor Qh is connected to the gate line 121, a second terminal thereof is connected to the first data line 171h, and a third terminal thereof is connected to the first capacitor Clch.

A first terminal of the second thin film transistor Ql is connected to the gate line 121, a second terminal thereof is connected to the second data line 171l, and a third terminal thereof is connected to the second capacitor Clcl.

When a gate-on voltage is applied to the gate line 121, the first thin film transistor Qh and second thin film transistor Ql, and the capacitors Clch and Clcl are charged with data voltages respectively transmitted through the data lines 171h and 171l. In an embodiment, data voltage transmitted through the second data line 171l may be lower than the data voltage transmitted through the first data line 171h. Accordingly, the second capacitor Clcl is charged with a lower voltage than the first capacitor Clch, such that satisfactory side visibility of images displayed by the display device 1000 may be attained.

Referring to FIGS. 4 and 5, the curved display device 1000 includes a display panel 100, a display panel 200, and a liquid crystal layer 3 interposed between the two display panels 100 and 200.

A gate line 121 and gate electrodes 124h and 124l (which may project from the gate line 121) are positioned on a substrate 110, which may be made of transparent glass or plastic.

The first substrate 110 may be made of a bendable material.

The gate line 121 may extend in the first direction D1 in a plan view of the pixel and may transmit a gate signal. The first gate electrode 124h and the second gate electrode 124l may project upward from the gate line 121 in the plan view of the pixel. The first gate electrode 124h and the second gate electrode 124l may be connected together and may form one integrated projecting portion that projects from the gate line 121. In an embodiment, the first gate electrode 124h and the second gate electrode 124l may have various shapes.

A storage electrode line 131 and storage electrodes 133 and 135 (which may project from the storage electrode line 131) may be positioned on the substrate 110.

The storage electrode line 131 may extend parallel to the gate line 121 and may be spaced from the gate line 121. A constant voltage may be applied to the storage electrode line 131. The storage electrode 133 may project upward from the storage electrode line 131 and may surround or overlap the edges of the first subpixel area PXa in the plan view of the pixel. The storage electrodes 135 may project downward from the storage electrode line 131 and may overlap a first drain electrode 175h and a second drain electrode 175l.

A gate insulating layer 140 is formed over the gate line 121, the first gate electrode 124h, the second gate electrode 124l, the storage electrode line 131, and the storage electrodes 133 and 135. The gate insulating layer 140 may be made of an inorganic insulating material, such as a silicon nitride (SiNx) or a silicon oxide (SiOx). The gate insulating layer 140 may have a single layer structure or a multiple layer structure.

A first semiconductor 154h and a second semiconductor 154l are formed on the gate insulating layer 140. The first semiconductor 154h may be disposed above the first gate electrode 124h, and the second semiconductor 154l may be disposed above the second gate electrode 124l. The first semiconductor 154h may be formed under the first data line 171h, and the second semiconductor 154l may be formed under the second data line 171l. The first semiconductor 154h and the second semiconductor 154l may be made of at least one of amorphous silicon, polycrystalline silicon, a metal oxide, and so on.

An ohmic contact member (not shown) may be formed over each of the first and second semiconductors 154h and 154l. The ohmic contact member may be made of, for example, a silicide or n+hydrogenated amorphous silicon doped with an n-type impurity at a high concentration.

A first data line 171h, a second data line 171l, a first source electrode 173h, a first drain electrode 175h, a second source electrode 173l, and a second drain electrode 175l are formed on the first semiconductor 154h, the second semiconductor 154l, and the gate insulating layer 140.

The first data line 171h and the second data line 171l may transmit data signals, may extend in the second direction D2, and may intersect the gate line 121 and the storage electrode line 131 in the plan view of the pixel.

The first data line 171h and the second data line 171l may transmit different data voltages. For example, the data voltage transmitted through the second data line 171l is lower than the data voltage transmitted through the first data line 171h.

The first source electrode 173h may project over the first gate electrode 124h from the first data line 171h, and the second source electrode 173l may project over the second gate electrode 124l from the second data line 171l. The first drain electrode 175h and the second drain electrode 175l each may include a relatively wide end portion and a relatively narrow bar-shaped end portion. The wide end portions of the first drain electrode 175h and second drain electrode 175l overlap the storage electrodes 135, which project downward from the storage electrode line 131. The bar-shaped end portions of the first drain electrode 175h and second drain electrode 175l are partially surrounded by the first source electrode 173h and the second source electrode 173h, respectively, in the plan view of the pixel electrode.

The gate electrodes 124h and 124l, the source electrodes 173h and 173l, and the drain electrodes 175h and 175l, along with the semiconductors 154h and 154l, constitute two thin film transistors (TFTs) Qh and Ql, respectively. A channel of each of the thin film transistors may be positioned in the associated semiconductor between the associated source electrode and the associated drain electrode.

A passivation layer 180 is formed over the first data line 171h, the second data line 171l, the first source electrode 173h, the first drain electrode 175h, a portion of the first semiconductor layer 154h exposed between the first source electrode 173h and the first drain electrode 175h, the second source electrode 173l, the second drain electrode 175l, and a portion of the second semiconductor layer 154l exposed between the second source electrode 173l and the second drain electrode 175l. The passivation layer 180 may be made of an organic insulating material or an inorganic insulating material and may have a single layer structure or a multiple layer structure.

Color filters 230 may be formed on the passivation layer 180. The color filters 230 may be formed along the second direction D2. In an embodiment, the color filters 230 may be formed on the upper panel 200.

Each color filter 230 may display one of primary colors, which may include one or more of red, green, blue, cyan, magenta, yellow, white-based colors, etc.

A second passivation layer 240 may be formed on the color filters 230. The second passivation layer 240 may be made of an organic insulating material and may planarize the surfaces of the color filters 230. The second passivation layer 240 may consist of a layer made of an organic insulating material and a layer made of an inorganic insulating material. The second passivation layer 240 may be omitted in some embodiments.

A first contact hole 181h exposing the wide end portion of the first drain electrode 175h and a second contact hole 181l exposing the wide end portion of the second drain electrode 175l are formed in the passivation layer 180 and the second passivation layer 240.

A pixel electrode 191 is formed on the second passivation layer 240. The pixel electrode 191 may be made of a transparent metal oxide such as, one or more of indium tin oxide (ITO), indium zinc oxide (IZO), etc.

The pixel electrode 191 includes a first subpixel electrode 191h and a second subpixel electrode 191l. The first subpixel electrode 191h is disposed in the first subpixel area PXa, and the second subpixel electrode 191l is disposed in the second subpixel area PXb. Thin film transistors Qh and Ql are disposed between the first subpixel electrode 191h and the second subpixel electrode 191l.

The first subpixel electrode 191h is connected to the first drain electrode 175h via the first contact hole 181h, and the second subpixel electrode 191l is connected to the second drain electrode 175l via the second contact hole 181l . When the first thin film transistor Qh and the second thin film transistor Ql are in the on state, the first subpixel electrode 191h and the second subpixel electrode 191l may receive different data voltages from the first drain electrode 175h and the second drain electrode 175l, respectively.

The overall shapes of the first subpixel electrode 191h and the second subpixel electrode 191l are substantially rectangular, and the first subpixel electrode 191h and the second subpixel electrode 191l may include cross-like stem portions consisting of horizontal stem portions 193h and 193l and vertical stem portions 192h and 192l crossing the horizontal stem portions 193h and 193l, respectively. The first subpixel electrode 191h and the second subpixel electrode 191l may include a plurality of minute branch portions 194h and 194l.

The pixel electrode 191 is divided into sub-regions by the horizontal stem portions 193h and 193l and the vertical stem portions 192h and 192l. The minute branch portions 194h and 194l obliquely extend from the horizontal stem portions 193h and 193l and the vertical stem portions 192h and 192l, and the direction of extension may form an angle of approximately 45 degrees or 135 degrees with the gate line 121 or the horizontal stem portions 193h and 193l. Extension directions of minute branch portions 194h and 194l of two neighboring sub-regions may be perpendicular to each other.

In an embodiment, the first subpixel electrode 191h and the second subpixel electrode 191l may further include outer stem portions surrounding or overlapping the outer edges of the first subpixel PXa and second subpixel PXb, respectively.

The light blocking member 220 may be positioned on a substrate 210, which may be made of transparent glass or plastic.

The second substrate 210 may be made of a bendable material.

The light blocking member 220 may be a black matrix and may prevent or minimize light leakage in the display device 1000. The light blocking member 220 may include the first light blocking member 220a and the second light blocking member 220b. The first light blocking member 220a may extend in the first direction D1 in a plan view of the display device 1000. The second light blocking member 220b may extend in the second direction D2 in a plan view of the display device 1000. The first light blocking member 220a overlaps the gate lines 121 and the thin film transistors Qa and Qb. The second light blocking member 220b overlaps the data lines 171.

The first substrate 110 and the second substrate 210 may be combined after the gate line 121, the data lines 171, the thin film transistors Qa and Qb, etc. have been formed on the first substrate 110 and after the light blocking member 220, etc. have been formed on the second substrate 210. When the combination of the first substrate 110 and the second substrate 210 are bent with respect to the first direction D1, misalignment may occur between the first substrate 110 the second substrate 210.

As a result of the misalignment, the second light blocking member 220b may still substantially cover the data lines 171 or may not substantially overlap the data lines 171 in directions normal (or perpendicular) to curved surfaces of the substrates 110 and 210. As the first light blocking member 220a extends in the first direction D1 before the bending, the first light blocking member 220a may not significantly block any pixel electrode and may still substantially completely overlap the gate line 121 and the thin film transistors Qa and Qb after the combination of the first substrate 110 and the second substrate 210 have been bent even if misalignment occurs. The gate line 121 may be curved after the bending.

The thin film transistors Qa and Qb may occupy a substantially large area, and the thin film transistors Qa and Qb may be substantially completely covered by the light blocking member 220 even if misalignment between panels 100 and 200 occurs. In the bending process, the first light blocking member 220a and the pixel electrode 191 may not have significant relative movement in the second direction D2; therefore, the pixel electrode 191 may remain substantially unblocked by the first light blocking member 2201. Thus, light leakage in the display device 1000 may be minimized or substantially prevented, and sufficient light transmittance may be maintained. Advantageously the curved display device 1000 may display images with satisfactory quality.

An overcoat layer 250 may be formed over the light blocking member 220. The overcoat layer 250 may planarize the second substrate 210.

A common electrode 270 is formed on the overcoat layer 250. The common electrode 270 may be made of a transparent metal oxide, such as at least one of indium tin oxide (ITO), indium zinc oxide (IZO), etc. The common electrode 270 may be formed over the entire surface of the second substrate 210. In an embodiment, the common electrode 270 may have slits. In an embodiment, the common electrode 270 may be formed on the lower panel 100, rather than on the upper panel 200.

A first alignment layer 11 and a second alignment layer 21 may be formed on opposite sides of the lower panel 100 and the upper panel 200, respectively. The first alignment layer 11 and the second alignment layer 21 may be vertical alignment layers, and the surfaces of the alignment layers may have distal end portions sloping in different directions depending on the area. The first alignment layer 11 may be disposed over the pixel electrode 191 on the lower display panel 100, and the second alignment layer 21 may be disposed over the common electrode 270 on the upper display panel 200.

The liquid crystal layer 3 may include a plurality of liquid crystal molecules 310 having negative dielectric anisotropy.

Although not shown, polarizers may be formed on the outer sides of the lower panel 100 and upper panel 200.

The layout of a pixel, the structure of a thin film transistor, and the shape of a pixel electrode may be modified in various embodiments.

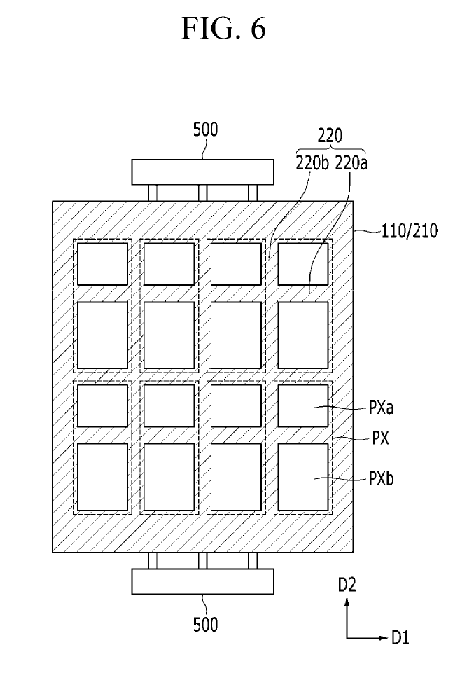

FIG. 6 is a schematic plan view illustrating elements and/or structures in the curved display device 1000 according to an embodiment of the present invention. The display device 1000 may have one or more of the features discussed with reference to one or more of FIG. 1, FIG. 2, FIG. 3, FIG. 4, and FIG. 5.

Referring to FIG. 6, two driving parts 500 may be positioned at two opposite edges of the first substrate 110 and/or at two opposite edges of the second substrate 210. The driving parts 500 may generate signals for driving the curved display device 1000.

In an embodiment, the upper half of the curved display device 1000 may be driven by the driving part 500 disposed at the upper edge, and the lower half of the display device 1000 may be driven by the driving part 500 disposed at the lower edge.

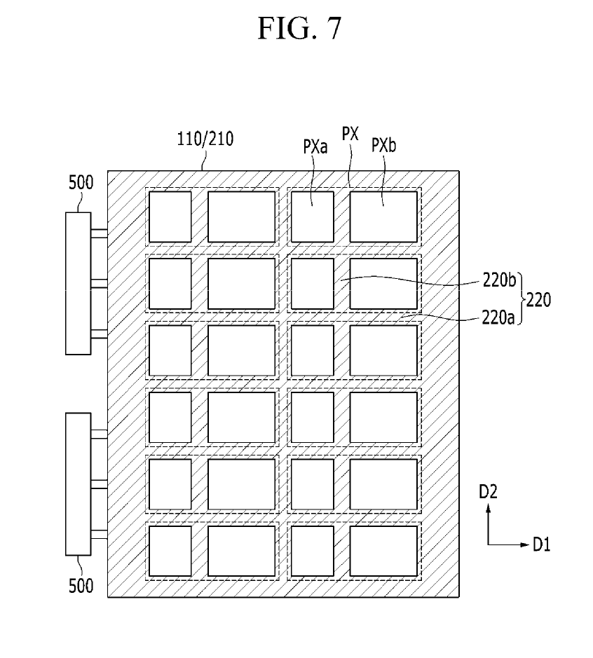

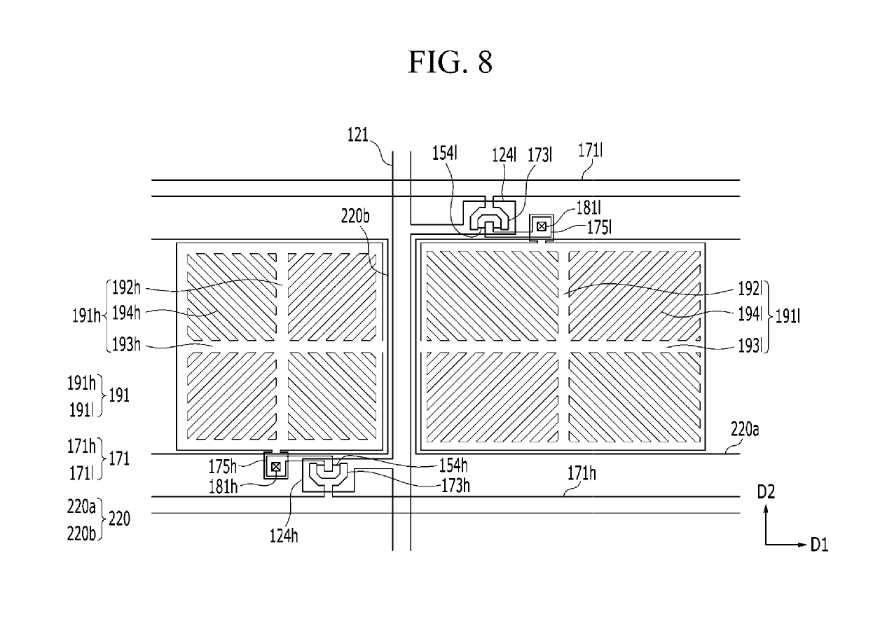

FIG. 7 is a schematic plan view illustrating elements and/or structures in the curved display device 1000 according to an embodiment of the present invention. FIG. 8 is a schematic plan view illustrating elements and/or structures in a pixel of the curved display device 1000 according to an embodiment of the present invention. The display device 1000 may have one or more of the features discussed with reference to one or more of FIG. 1, FIG. 2, FIG. 3, FIG. 4, FIG. 5, and FIG. 6.

Referring to FIG. 7, the curved display device 1000 includes a plurality of pixel areas PX. Each pixel area PX may have a quadrangle shape including two relatively long sides and two relatively short sides. The long sides may extend in the first direction D1 in a plan view of the display device 1000. The short sides may extend in the second direction D2, which is perpendicular to the first direction D1, in the plan view of the display device 1000.

Each of the pixel areas PX may include a first subpixel area PXa and a second subpixel area PXb. The first subpixel area PXa and the second subpixel area PXb may be aligned with each other in the first direction D1 in a plan view of the display device 1000.

In an embodiment, each pixel area PX may include three or more subpixel areas. In an embodiment, each pixel area PX may not be split into a plurality of subpixel areas.

The first-type light blocking members 220a may extend in the first direction D1 in a plan view of the display device 1000 and may be disposed between the pixel areas PX. The second-type light blocking members 220b may extend in the second direction D2 and may be disposed between first subpixel areas PXa and second subpixel areas PXb. A first first-type light blocking member 220a may cover a transistor Qh and a data line 171h; a second first-type light blocking member 220a may cover a transistor Ql and a data line 171l. Each of the data lines 171h and 171l may be curved. The first first-type light blocking member 220a and the second first-type light blocking member 220a may be spaced from each other. Each of a subpixel electrode 191h and a subpixel electrode 191l may be positioned between the transistor Qh and the transistor Ql. Each second-type light blocking member 220b may overlap (and may substantially cover) a gate line 121.

A driving part 500 is formed at an edge of the first substrate 110 and/or at an edge of the second substrate 210. The driving part 500 may generate signals for driving the curved display device 1000. Referring to FIG. 8, the curved display device 1000 includes a gate line 121, a first data line 171h, and a second data line 171l that are formed on the first substrate 110.

The gate line 121 extends in the second direction D2, and the data lines 171 extend in the first direction D 1. The gate line 121 and the data lines 171 cross each other in a plan view of the display device 1000. The data lines 171 include a first data line 171h and a second data line 171l. The first data line 171h is disposed below the pixel electrode 191, and the second data line 171l is disposed above the pixel electrode 191.

A first gate electrode 124h and a second gate electrode 124l may project from the gate line 121. The first gate electrode 124h projects to the left from the gate line 121, and the second gate electrode 124l projects to the right from the gate line 121.

A first source electrode 173h and a second source electrode 175l are formed to project from the data lines 171. The first source electrode 173h is disposed above the first gate electrode 124h, projecting from the first data line 171h. The second source electrode 175l is disposed above the second gate electrode 124l, projecting from the second data line 171l.

A first drain electrode 175h is formed in such a manner so as to be spaced apart from the first source electrode 173h, and a first subpixel electrode 191h is formed in such a manner so as to be connected to the first drain electrode 175h. A second drain electrode 175l is formed in such a manner so as to be spaced apart from the second source electrode 173l, and a second subpixel electrode 191l is formed in such a manner so as to be connected to the second drain electrode 175l.

The first subpixel electrode 191h is disposed in the first subpixel area PXa, and the second subpixel electrode 191l is disposed in the second subpixel area PXb. The gate line 121 is disposed between the first subpixel electrode 191h and the second subpixel electrode 191l. Thin film transistors Qh and Ql are disposed above and below the pixel electrode 191. That is, the thin film transistors Qh and Ql are disposed between pixel areas PX adjacent in the second direction D2.

The light blocking member 220 may be formed on the second substrate 210.

Each first-type light blocking member 220a may extend in the first direction D1 in a plan view of the display device 1000 and may be disposed between at least two pixel areas PX. Each second-type light blocking member 220b may extend in the second direction D2 and may be disposed between at least one first subpixel area PXa and at least one second subpixel area PXb. A first first-type light blocking member 220a may cover the transistor Qh and the data line 171h; a second first-type light blocking member 220a may cover the transistor Ql and the data line 171l. The first first-type light blocking member 220a and the second first-type light blocking member 220a may be spaced from each other. Each of the subpixel electrode 191h and the subpixel electrode 191l may be positioned between the transistor Qh and the transistor Ql. A second light blocking member 220b may overlap (and may substantially cover) the gate line 121.

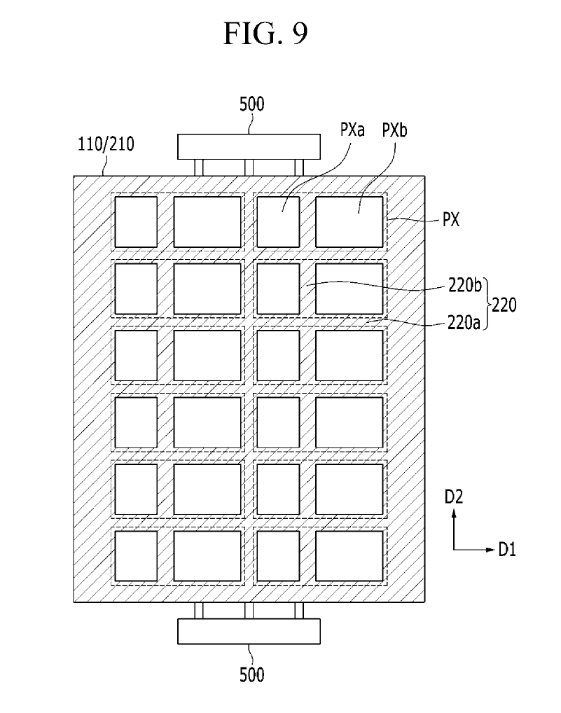

The thin film transistors Qh and Ql may be substantially covered by the first light blocking members 220a even if misalignment between the first substrate 110 and the second substrate 210 occurs after the combination of the first substrate 110 and the second substrate 210 have been bent with respect to the first direction D1. Accordingly, any decrease in transmittance due to misalignment of the upper display panel 100 and the lower display panel 200 can be minimized or substantially prevented. Advantageously, the display device 1000 may display images with satisfactory quality. FIG. 9 is a schematic plan view illustrating elements and/or structures in the curved display device 1000 according to an embodiment of the present invention. The display device 1000 may have one or more of the features discussed with reference to one or more of FIG. 1, FIG. 2, FIG. 3, FIG. 4, FIG. 5, FIG. 6, FIG. 7, and FIG. 8.

Referring to FIG. 9, two driving parts 500 may be positioned at two opposite edges of the first substrate 110 and/or at two opposite edges of the second substrate 210. The driving parts 500 may generate signals for driving the curved display device 1000.

While this invention has been described in connection with what is presently considered to be practical embodiments, the invention is not limited to the disclosed embodiments. This invention is intended to cover various modifications and equivalent arrangements included within the spirit and scope of the appended claims.

What is claimed is:

1. A curved display device comprising:
a pixel electrode;
a first thin film transistor, which is electrically connected to the pixel electrode;
a first curved light blocking member, which overlaps the first thin film transistor; and
a light blocking portion, which is directly connected to the first curved light blocking member and is perpendicular to a first geometric radius of curvature associated with the first curved light blocking member.

2. The curved display device of claim 1, wherein the light blocking portion is perpendicular to the first curved light blocking member in a plan view of the curved display device.

3. The curved display device of claim 1, further comprising:
a second pixel electrode;
a second thin film transistor, which is electrically connected to the second pixel electrode,
wherein the first thin film transistor is oriented according to a first geometric plane,
wherein the second thin film transistor is oriented according to a second geometric plane,
wherein the second geometric plane is different from the first geometric plane and is not parallel to the first geometric plane, and
wherein the first curved light blocking member overlaps both the first thin film transistor and the second thin film transistor.

4. The curved display device of claim 1, further comprising a second thin film transistor,
wherein the pixel electrode includes a first subpixel electrode and a second subpixel electrode,
wherein the first thin film transistor is electrically connected to the first subpixel electrode,
wherein the second thin film transistor is electrically connected to the second subpixel electrode, and
wherein the first curved light blocking member covers both the first thin film transistor and the second thin film transistor.

5. The curved display device of claim 4, wherein the first subpixel electrode is aligned with the second subpixel electrode in a direction perpendicular to a second geometric radius of curvature associated with the first curved light blocking member.

6. The curved display device of claim 4, wherein the first thin film transistor overlaps the first curved light blocking member in an extending direction of a second geometric radius of curvature associated with the first curved light blocking member.

7. The curved display device of claim 4, wherein the first subpixel electrode receives a first voltage, wherein the second subpixel receives a second voltage, wherein a value of the second voltage is unequal to a value of the first voltage.

8. The curved display device of claim 1, further comprising a curved gate line, which is electrically connected to a gate electrode of the first thin film transistor and overlaps the first curved light blocking member.

9. The curved display device of claim 1, further comprising:
a second thin film transistor,
a second curved light blocking member, which overlaps the second thin film transistor,
wherein the pixel electrode includes a first subpixel electrode and a second subpixel electrode,
wherein the first thin film transistor is electrically connected to the first subpixel electrode, and
wherein the second thin film transistor is electrically connected to the second subpixel electrode.

10. The curved display device of claim 9, wherein at least one of the first subpixel electrode and the second subpixel electrode is positioned between the first thin film transistor and the second thin film transistor in a plan view of the curved display device.

11. The curved display device of claim 9, wherein the second curved light blocking member is parallel to the first curved light blocking member.

12. The curved display device of claim 9, wherein a first side of the first subpixel electrode is parallel to the first curved light blocking member in a plan view of the curved display device, wherein a second side of the first subpixel electrode is parallel to the light blocking portion in the plan view of the curved display device, and wherein the first side of the first subpixel electrode is longer than the second side of the first subpixel electrode.

13. The curved display device of claim 9, further comprising:
a first curved data line, which is electrically connected to a source electrode of the first thin film transistor and overlaps the first curved light blocking member; and
a second curved data line, which is electrically connected to a source electrode of the second thin film transistor and overlaps the second curved light blocking member.

14. The curved display device of claim 9, further comprising a gate line, which is electrically connected to a gate electrode of the first thin film transistor and overlaps the light blocking portion.

15. The curved display device of claim 9, wherein the light blocking portion is positioned between the first thin film transistor and the second thin film transistor in a plan view of the curved display device.

16. The curved display device of claim 1, further comprising:
a first driver, which is configured to generate a first set of signals for a first portion of the curved display device; and
a second driver, which is configured to generate a second set of signals for a second portion of the curved display device,
wherein the first curved light blocking member is positioned between the first driver and the second driver in a plan view of the curved display device.

17. The curved display device of claim 1, further comprising:
a first driver, which is configured to generate a first set of signals for a first portion of the curved display device; and
a second driver, which is configured to generate a second set of signals for a second portion of the curved display device,
wherein the first curved light blocking member is aligned with the first driver in a direction in a plan view of the curved display device and is not aligned with the second driver in the direction in the plan view of the curved display device.

18. A curved display device comprising:
a substrate, which is bent with respect to a first direction;
a first thin film transistor;
a pixel electrode electrically connected to the first thin film transistor; and
a light blocking member disposed on the substrate and comprising a first light blocking portion, wherein the first light blocking portion extends in the first direction in a plan view of the curved display device and overlaps the first thin film transistor.

19. The curved display device of claim 18, further comprising:
a gate line electrically connected to a gate electrode of the first thin film transistor; and
a data line electrically connected to a source electrode of the first thin film transistor,
wherein the first light blocking portion overlaps at least one of the gate line and the data line.

20. The curved display device of claim 19, further comprising a second thin film transistor, wherein the first thin film transistor is electrically connected to a first subpixel electrode of the pixel electrode, wherein the second thin film transistor is electrically connected to a second subpixel electrode of the pixel electrode, wherein the light blocking member further comprises a second light blocking portion, and wherein the second light blocking extends perpendicular to the first light blocking portion in the plan view of the curved display device and is positioned between the first thin film transistor and the second thin film transistor in the plan view of the curved display device.
